(19) United States
(12) Patent Application Publication
(10) Pub. No.: US 2012/0146753 A1
(43) Pub. Date: Jun. 14, 2012

(54) INTEGRATED MULTI-PHASE PLANAR TRANSFORMER

(75) Inventors: Richard Lukso, Tucson, AZ (US); Richard Bodkin, Tucson, AZ (US)

(73) Assignee: Panacis, Inc., Ottawa (CA)

(21) Appl. No.: 13/390,687

(22) PCT Filed: Aug. 18, 2010
(86) PCT No.: PCT/IB10/53721

§ 371 Date: Feb. 15, 2012

Related U.S. Application Data
(60) Provisional application No. 61/234,977, filed on Aug. 18, 2009.

(51) Int. Cl. H01F 30/12

(52) U.S. Cl. 336/5

(57) ABSTRACT

An n-phase transformer includes a core structure having a polygonal top plate and a polygonal bottom plate and n winding posts disposed symmetrically between the top and bottom plate. The primary and secondary winding loops are integrated into printed circuit boards which are then stacked over the posts in laminate fashion between the top and bottom plate.

### TECHNICAL FIELD

This invention is related to electrical transformers and specifically to an integrated multi-phase high-frequency planar transformer.

### BACKGROUND ART

Transformers are often used in electronic systems to transfer electrical energy from one circuit to another and to step-up or step-down the voltage of electrical signals. In long-distance transmission lines, for example, transformers are used to step-up the transmission voltage from several hundred volts to more than 100 KV for long-distance transmission. In other circuits, transformers are used to step-down voltages for low-voltage applications such as personal electronic devices (e.g., cell phones or computers) or toys. Transformers may also be used in signal processing applications to couple stages of an amplifier circuit. Transformers also can act as safety devices to provide current-limiting functionality in electrical short situations such as those found in some welding applications.

Multi-phase transformers are often used in industrial settings where very high power is required. These applications are commonly fixed or stationary in nature. The design intent for these stationary multi-phase transformers is primarily on cost.

In aviation and other mobile applications, multiphase transformers may be employed as a way to save weight when compared to the use of multiple single-phase transformers. A single phase transformer is generally constructed with a center core and at least one flux return path to produce a complete magnetic circuit. In multi-phase transformers there is a phase, or winding, around more than one core and therefore the cores themselves can provide a magnetic flux return path for each other, eliminating the need for a separate return path and therefore eliminating the weight, volume and cost of material used to construct the return path. For weight sensitive applications, there exists a need for a multi-phase transformer core design that is specifically designed to optimize the weight savings.

Multi-phase transformers could be applied in settings where high efficiency is required such as multi-phase DC to DC converter circuits (changing one Direct Current voltage to another Direct Current voltage). In such a case an input voltage may be switched at high frequency into multiple phases of the transformer then rectified and combined into a single output signal. The use of multiple phases in such a system are a dramatic reduction in input and output ripple as one phase can be supplying energy to the load while another phase is being energized.

When operating at the high frequencies employed in DC to DC converter systems, conventional multi-phase transformers have a number of serious limitations. Conventional transformers are formed on a core that has three legs, each with multiple windings present on it. However, the magnetic path from leg to leg is not even. This causes the magnetic resistance in each leg to be different and may therefore contribute to uneven losses and even loss of circuit control. Magnetic losses are generally higher in smaller transformers because the total flux concentrated inside the core is higher. Increased operating frequency also increases core losses as the magnetic flux is forced to change at a higher rate of change. For all of these reasons there exists a need for a balanced multi-phase transformer core.

Transformers are usually constructed by passing multiple turns of wire around the core. Several improvements in the types of wire, the shape of the wire itself and the method of winding have been proposed. As frequency of operation is increased, fewer turns of wire are required. It is possible to increase operating frequency to the point where only a few turns of wire are required. Maintaining accurate winding lengths, wire placement on the core, tension of the wire and turns ratio is exceedingly difficult as the number of turns is reduced towards one turn. Accurately maintaining the winding of the transformers is critical in DC to DC conversion circuits in order to maximize efficiency. Balance on each of the phases in a multi-phase system is also impacted by winding variation. There exists a need to more accurately control windings on a high-frequency multi-phase transformer.

Toroidal transformers are often employed to reduce weight. These transformers are based on a donut shaped core of magnetic material that has wire wrapped around it. Toroids are highly efficient as the entire ring of material may be used for carrying the wire turns and for carrying the flux. The principle disadvantages of toroids lies in the need to wind wire around the entire periphery in order to gain the full advantage of the design, this generally requires difficult winding techniques for the wire and is unsuited for use with planar style designs. It is also difficult to maintain even wire spacing and turns ratios. There exists a need for a transformer with similar weight savings to toroids, but with easier winding and higher accuracy.

Throughout this application, the concept of the core structure being assembled, connected or otherwise having certain mechanical features is taken in the sense of magnetic flux connections. Such plates, posts and cores may be constructed from multiple elements which are brought in proximity to each other in such a way that a magnetic circuit is formed. The actual physical connection between the various structures may be permanent in nature, may be part of the manufacturing process, or may be accomplished through any other positioning means be it temporary, frictional, clamps or frames. The entire structure may also be constructed from a single fused element such as would be found in injection molding casting or sintering. The fundamental nature of the shape, size and magnetic circuit is the principle concern herein.

### DISCLOSURE OF INVENTION

### Technical Problem

Overall, there exists a need for a multi-phase planar transformer design that provides weight savings, balanced flux paths and highly accurate conductor turns ratio which can be constructed rapidly and repeatedly.

### Technical Solution

In one embodiment, the present invention is a transformer comprising a core structure. The core structure comprises a first plate having a triangular-shaped perimeter and three planes of symmetry, and three first core posts connected to a surface of the first plate. Each first core post is positioned along a different one of the three planes of symmetry of the first plate. The core structure includes a second plate having a triangular-shaped perimeter and three planes of symmetry, and three second core posts connected to a surface of the second plate. Each second core post is positioned along a different one of the three planes of symmetry of the second plate. Each second core post is connected to a different first core post. The transformer comprises primary windings formed around each of the first core posts or second core posts, and secondary windings formed around each of the first core posts or second core posts.

In another embodiment, the present invention is a transformer comprising a core structure. The core structure includes a high-magnetic permeability material and includes a first plate having three planes of symmetry, a second plate having three planes of symmetry, and core posts connected to the first plate or second plate. Each core post is positioned along one of the three planes of symmetry of the first plate or second plate. The transformer includes windings formed around the core posts.

In another embodiment, the present invention is a transformer comprising a core structure. The core structure includes a first plate having planes of symmetry, a second plate having planes of symmetry, and core posts connected to the first plate or the second plate. Each core post is positioned along one of the planes of symmetry of the first plate or the second plate.

In another embodiment, the present invention is a method of manufacturing a transformer comprising forming a core structure using a molding fabrication process applied to a high-magnetic permeability material. Forming the core structure including forming a first plate having planes of symmetry, and connecting first core posts to a surface of the first plate. Each first core post is positioned along one of the planes of symmetry of the first plate. Forming the core structure includes forming a second plate having planes of symmetry, and connecting second core posts to a surface of the second plate. Each second core post is positioned along one of the planes of symmetry of the second plate. The second core posts are connected to the first core posts. The method includes forming windings around the first core posts or the second core posts.

### DESCRIPTION OF DRAWINGS

Implementations will become more apparent from the detailed description set forth below when taken in conjunction with the drawings, in which like elements bear like reference numerals.

FIGS. 1a and 1b illustrate a prior art conventional three-phase transformer having an E-Shaped core structure.

FIGS. 2a and 2b illustrate a perspective view of a three-phase planar transformer.

FIGS. 3a and 3b illustrates the flux paths in the three-phase planar transformer.

FIGS. 4a and 4b illustrate the optimum core size for a three phase planar transformer.

FIGS. 5a, 5b and 5c show the circuit board windings, core and sectional view of the planar transformer.

FIG. 6 shows a representative six-phase planar transformer.

### BEST MODE

The present invention is described in preferred embodiments in the following description with reference to the Figures, in which like numbers represent the same or similar elements. Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

The described features, structures, or characteristics of the invention may be combined in any suitable manner in one or more embodiments. In the following description, numerous specific details are recited to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

In aerospace applications, transformers are often used as part of the power-distribution system. In an airplane, for example, energy used to power the on-board electrical systems may be created by generators coupled to the plane's engines. In order to modify the electrical energy produced by the generators for use by the onboard systems, transformers are used to either step-up or step-down the input voltage to a desired value. Depending upon the number and type of on-board systems, several different transformers having different winding configurations may be necessary to generate an electricity supply for each of the on-board systems. If the generators provide a three-phase electricity supply, three separate transformers or an integrated three-phase transformer may be required for energy distribution.

Generally, a transformer includes two windings of conductive material formed around a core material. Depending upon the transformer, the two windings may have a different number of turns and are wound around a mutual core formed of a high-magnetic permeability material such as high-permeability silicon steel. When the transformer is energized, a changing current passing through the first winding generates a corresponding changing magnetic field that propagates through the first winding, the core and, subsequently, the second winding. This changing magnetic field induces a corresponding voltage across the second winding. If the second winding is connected to a load, a complementary current will flow through the second winding and through the load. In this configuration, the first and second windings are connected by electromagnetic induction and allow for electrical energy to be communicated or transferred from one winding to the other.

In most applications, transformers operate to either step-up or step-down a voltage applied to the first winding. For example, a transformer with an input voltage of 500 Volts Alternating-Current (VAC) may be configured to step-up that voltage to generate an output voltage across the second winding of 2500 VAC, with a corresponding drop in available current. These voltage modification characteristics of a transformer are controlled by the configuration of the first and second windings around the common core. Specifically, the ratio of turns in the first and second windings controls the ratio of input to output voltages of the transformer. For example, in a transformer having primary and second windings, the ratio of the numbers of turns in the primary (Np) to secondary (Ns) windings is equal to the ratio of the voltage across the primary winding (Vp) to that across the secondary winding (Vs) as illustrated in Equation 1:

Vs/Vp=Ns/Np

As a transformer operates with an AC input, the core material is constantly being magnetized and demagnetized by the magnetic field generated by the primary winding. If the input frequency is too low, the core material may become saturated with magnetic flux resulting in a sharp increase in the current flowing through the first winding and overheating of the transformer. This condition can often result in device failure. At a given input frequency, therefore, the core material must have a sufficient magnetic flux capacity to prevent saturation. Because the magnetic flux capacity is dependent upon the geometry of the core structure, the core structure of a transformer at a given frequency has a minimum size. As a result, at relatively low frequencies, transformers tend to be extremely bulky and heavy.

In three-phase electrical systems, multiple transformers having more than two windings may be used to adjust the voltage characteristics of each phase in the distribution system. In high-energy power delivery systems, for example, a three-phase transformer may be used to step-up or step-down voltages across the three-phases for efficient long-distance delivery.

Three-phase transformers can be manufactured using a collection of individual, isolated single-phase transformers connected to each phase, or by combining a plurality of transformer windings with a single core structure. In three-phase transformers having a single core structure, the windings for each phase of the system are formed around separate portions of the core structure. As the transformer operates, a three-phase flow of flux created by the three primary windings is generated within the core structure.

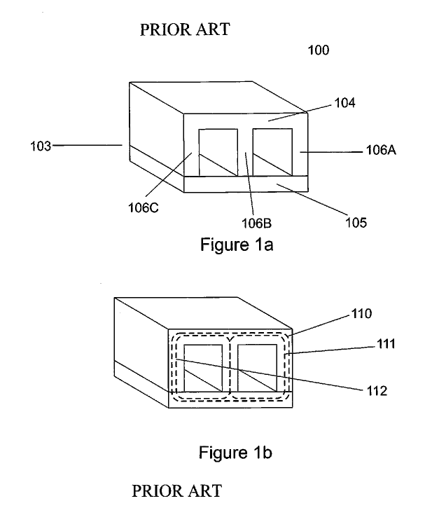

FIG. 1a illustrates a prior art conventional three-phase transformer (100). FIG. 1a shows that the core structure is formed of two separate cores. One is in the shape of an ‘E’ and is called the E-Core (104) and is attached to a flat plate (105) which together form the entire core. Windings would be passed around each of the core legs (106A, 106B, 106C). The windings are not shown to improve clarity of the drawing. Plate (105) is connected to the E-Core (104) by an of a variety of methods form a continuous core structure for the device. The continuous core structure facilitates the distribution of magnetic flux throughout core structure. In this configuration, although straightforward to fabricate, the E-shaped core structure is not symmetrical with respect to each of the three pairs of windings. As a result, the flux paths for each phase or leg of the system are not balanced causing inefficient operation.

FIG. 1b shows the flux paths as a dashed line. The flux path from leg 106A would travel along the short loop (111) and the long loop (110). Flux from leg 106C would also travel along a short loop (112) and the long loop (110). However, flux from the center leg 106B would travel around only the short loops (111 and 112). This loop imbalance necessitates that a flux gap be added to many transformer cores in order to force losses to occur which will keep the core from saturation. This gap is usually included as part of the assembly structure by widening the gap (103) between the two core structures (104) and (105).

Because transformers tend to be heavy, bulky devices they can present significant costs when used in aerospace applications where a minimization of size and weight is crucial to high-performance systems.

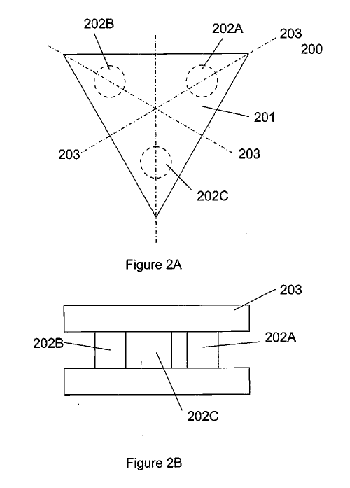

FIG. 2A is a top view illustration of one embodiment of the invention which is an integrated three-phase high-frequency planar transformer having a core structure (200). FIG. 2B is a front view of the embodiment of FIG. 2A.

The top plate (201) and bottom plate (205) of the core structure are essentially flat triangles. The three core posts (202A, 202B, 202C) connect the top plate (201) to the bottom plate (205).

In one embodiment, core structure (200) is formed using a molding fabrication process. Alternatively, the core structure can be made using a cutting or etching process applied to a solid piece of material. In that case, the core structure may be fabricated using a computer-guided cutting or routing tool. In other implementations, the core structure is formed by joining pieces of material that are separately fabricated. For example, each core post (202A, 202B, 202C) may be manufactured and then mounted to the top (201) and bottom (205) plates.

Generally, the core structure includes a high-permeability material such as iron, steel, laminated steel, high permeability silicon steel, or ceramic materials such as ferrites. In other embodiments, however, any suitable core material may be used—even one that does not provide high-efficiency magnetic flux distribution. In other implementations the core structure includes zinc, or other doped ferrite materials.

As shown in FIGS. 2A and 2B, the top plate (201) and bottom plate (205) are formed as approximately planar structures having a consistent thickness. The perimeters of both plates form an equilateral triangular shape.

Still referring to FIG. 2A and FIG. 2B, a critical feature of the design ensures that the flux path from each core post is balanced and completely symmetrical to each other. If lines of symmetry (203) were passed through the core, they would cross at the center and be at all times of equal angles to each other.

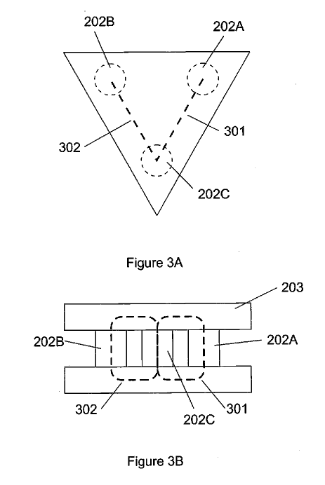

Referring to FIGS. 3A and 3B, flux line paths 301 and 302 are shown. Windings would be positioned around each of the core posts (202A, 202B, 202C). The flux from core post 202C would flow equally along two flux paths (301, 302) in both the overhead and the front-view of the core. This three-dimensional flux flow will be symmetrical and balanced when flowing from any one energized core post through the two return-path core posts. By positioning core posts in this manner, the magnetic flux characteristics of core structure presented to each of core posts and their respective windings is approximately equal. In other words, the core structure as viewed by each post looks the same. As a result, the magnetic flux generated by each winding of the transformer is balanced throughout core structure. The balancing of magnetic flux for each phase of the transformer results in more efficient and consistent operation of the transformer across all phases.

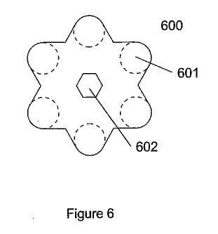

In other implementations of the present system, core structures may be manufactured using other numbers of core posts and phases. For example, a transformer in accordance with the present system may be manufactured using 6 phases as shown in FIG. 6. The core structure (600) supports six separate posts (601) and may include a hole in the center to reduce weight. In each core structure for any n-phases, the sets of core posts are positioned along each of the planes of symmetry found in the core structure.

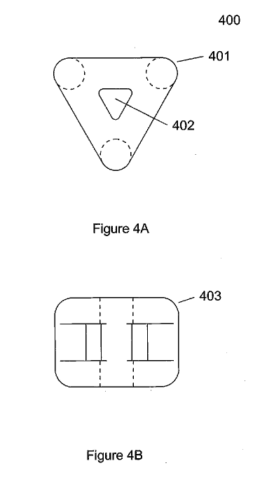

FIG. 4A and FIG. 4B shows the smallest expected core structure. FIG. 4A shows the core structure from a top view and includes rounded corners (401) which are brought up to the edges of the core posts. Flux flowing between the core posts will tend to not travel through the center of the core, as such the center may be removed leaving a hole (402) in the center of the structure without significantly affecting performance, provided appropriate design techniques have been employed to ensure adequate flux carrying material is used. Ideally the cross sectional area available for magnetic flux flow should be equal at all points in the flux path.

FIG. 4B shows the same core structure from a front view. The windings are not shown for simplicity. This shows that further rounding of the corners is possible (403) depending on the level of weight savings and the flux paths present in the core structure.

Although FIG. 4A and FIG. 4B show the smallest expected core structure, it is possible and may even be desirable in some circumstances to make the core somewhat larger than what is shown in these figures. For example, the hole (402) may dramatically increase the cost to manufacture the part with only minimal weight savings. It may also be desirable to allow the plate to have sharp corners or for the top plate and bottom plate to be larger than the core posts in order to dissipate extra heat, to aid in assembly, or for to allow for additional manufacturing tolerance. The top and bottom plate may also be of different sizes or configurations, provided the essence of balanced flux paths and planes of symmetry are maintained.

Additional advantages of this transformer design can be appreciated when comparing FIGS. 1a and 1b to FIGS. 4A and 4B. In particular the length of wire required to make one turn or loop is minimized when round cores are used as compared to square or rectangular legs. Heat dissipation area is also maximized for the planar transformer core and can be further improved by blowing air through the center hole (402) or by adding ridges and groves to the surfaces of the core to further improve dissipation. Referring to FIGS. 1a and 1b, it can be seen that the heat dissipation available to the posts will be unequal when comparing to outer legs (106 A, 106C) to the center leg (106B). Mounting the planar transformer is also simplified as it clamps around a circuit board, allowing a single bolt to pass through the center of the core, or for the use of adhesives or external clamps to hold the transformer core in place. Conventional toroids must sit on top of the circuit board due to their distributed windings.

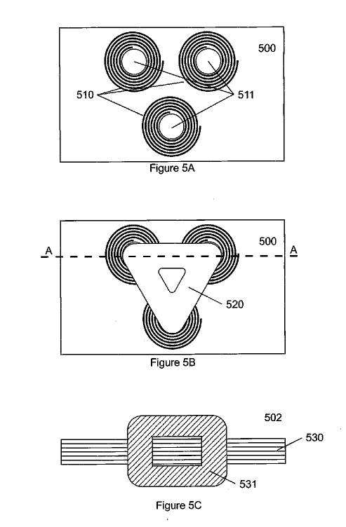

FIGS. 5A, 5B and 5C illustrate the winding structure employed in the planar transformer. FIG. 5A shows an example printed circuit board (500) with spiral windings (510) of copper located on the surface of the circuit board. These spirals are located around three holes (511) into which the core posts will fit.

FIG. 5B shows an overhead view of the core structure (520) installed on the circuit board (500). In this way the core structure (520) is effectively sandwiching the circuit board inside the core.

FIG. 5C illustrates a cross-sectional view of the transformer taken along Section A-A of FIG. 5B As shown, primary and secondary windings of each phase of the three-phase transformer are formed around posts on the core (531) by use of multiple circuit boards (530). It is also possible to form multiple windings on a single circuit board, on a fused multi-layer circuit board, or to form the windings through more conventional wire winding techniques. Alternatively, the windings are first formed within a separate support structure which is separately formed and configured to mount around the core posts. For example, multiple windings may be formed within an epoxy or other solid insulative support material to form a separate winding structure. The winding structure is configured with openings or holes to fit over the core posts and between the core top plate and bottom plate. Depending upon the application, the primary and secondary windings of each phase of the transformer may be formed with any number of turns; the numbers of turns in the primary and secondary windings may be different, and the number of windings between phases, and even the number of separate windings themselves may also vary.

The winding structure may include a plurality of stacked printed circuit boards (530). Each circuit board (500) comprises a substrate material such as polytetrafluoroethylene, other fluoropolymers such as FR-4, FR-1, CEM-1, CEM-3 or other insulating substrate materials, and is formed to include holes (511) disposed there through to accommodate the core posts. Conductive material is formed over a surface of or within each board around each of the openings to forms one or more loops, spirals or turns (510) within the primary or secondary windings of each phase of the transformer. The conductive loops include a material such as gold, silver or copper and are formed on a surface or within layers of boards (500) using evaporation, electrolytic plating, electro-less plating, screen printing, or another suitable metal deposition process or combination of processes. Depending upon the application, each board may include a single loop of conductive material, or may include several loops for each winding formed over one another on separate layers of each board.

While one or more embodiments of the present invention have been illustrated in detail, the skilled artisan will appreciate that modifications and adaptations to those embodiments may be made without departing from the scope of the present invention as set forth in the following claims.

1. An integrated n-phase planar transformer comprising a core structure comprising: a top plate and a bottom plate wherein said top plate and said bottom plate provide high-efficiency magnetic flux distribution within said core structure; n symmetrically disposed core posts connecting the top plate to the bottom plate so that said magnetic flux distribution within the core structure is balanced and symmetrical between said n core posts; and, a primary and secondary winding around each of the n core posts.

2. The transformer of claim 1 wherein n is equal to three so that the transformer is a three-phase transformer comprising a triangular top plate and a triangular bottom plate wherein each of said top plate and said bottom plate comprises three vertices.

3. The transformer of claim 2 wherein the plurality of core posts comprise three core posts disposed symmetrically proximate to each of said three vertices.

4. The transformer of claim 3 wherein the top plate and the bottom plate have central apertures for air flow and heat dissipation.

5. The transformer of claim 4 wherein each of said three core posts includes a primary and a second winding.

6. The transformer of claim 5 wherein said primary winding and said secondary winding each comprise at least one loop of a suitable conductor.

7. The transformer of claim 6 wherein said at least one loop of a suitable conductor is disposed upon a printed circuit board around an aperture for accepting one of said three core posts and further wherein said printed circuit board is disposed between the top plate and the bottom plate.

8. The transformer of claim 7 wherein the at least one loop of suitable conductor comprises a plurality of loops disposed upon a respective plurality of printed circuit boards disposed in a laminate fashion between the top plate and the bottom plate.

9. An integrated n-phase planar transformer comprising a laminated core structure comprising a polygonal top plate and a complementary polygonal bottom plate wherein said top plate and said bottom plate provide high-efficiency magnetic flux distribution within said core structure; n symmetrically disposed core posts connecting the top plate to the bottom plate so that said magnetic flux distribution within the core structure is balanced and symmetrical between said n core posts; a primary and secondary winding around each of the n core posts, wherein said primary and said secondary winding comprises a plurality of primary winding and secondary winding loops of a suitable conductive material disposed upon a respective plurality of printed circuit boards disposed in a laminate fashion between the top plate and the bottom plate; and an aperture disposed in the center of said laminated core structure from the top plate to the bottom plate for air movement and heat dissipation.

10. The transformer of claim 9 wherein each of n core posts is cylindrical thereby minimizing the length of conductor material used to complete a single winding loop.

11. The transformer of claim 9 wherein said suitable conductive material is one of copper, gold and silver.
